(19) United States
(12) Patent Application Publication
(10) Pub. No.: US 2023/0363974 A1
(43) Pub. Date: Nov. 16, 2023

(54) Mobility Aid

(71) Applicant: William Scott, Lithia, FL (US)

(72) Inventor: William Scott, Lithia, FL (US)

(21) Appl. No.: 18/220,664

(22) Filed: Jul. 11, 2023

Related U.S. Application Data
(60) Provisional application No. 63/340,540, filed on May 11, 2022.

(51) Int. Cl. A61H 3/02

(52) U.S. Cl. CPC A61H 3/02; A61H 3/0288; A61H 2201/1635; A61H 2003/0238

(57) ABSTRACT

A mobility aid in the form of a cuff crutch can be used in various configurations. The cuff crutch includes an arm cuff positioned at a distal end of a tube that is adjustably positioned into a main tube of the crutch. The main tube may be bent at an angle in a position below a mid-point thereof, that is, the bend is closer to the foot end of the main tube as opposed to the cuff end thereof. A foot tube may be adjustably positioned into the foot end of the main tube and a foot may be disposed on a distal end of the foot tube. By providing the various adjustments, the cuff crutch may be used as a cuff cane, a cuff crutch or a walking stick, as discussed herein. The cuff, grip, and foot may include designs that offer various improvements over conventional mobility aids.

### BACKGROUND OF THE INVENTION

### 1. Field of the Invention

Embodiments of the invention relates generally to mobility aids. More particularly, the invention relates to an improved cuff crutch design.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

For all the extraordinary technological advances made in medical devices over the past half century, crutches (including axilla and forearm styles), canes, walking sticks, substitute crutches and leg/foot prosthesis and walkers have fallen dangerously behind. The basic design of standard crutches, canes and walkers hasn't changed for decades, going back to when the first medical advice given to new patients was “take it easy and go slow.” Unstable, uncomfortable, inflexible and unattractive at best, their design actually impedes a user's return to max-mobility potential. Conventional mobility aid design also contributes to something most mobility device designers don't think about—the loss of dignity the user feels at having to rely on these archaic devices in the first place.

First, conventional mobility aids uncomfortable and fatiguing. This not only limits the time a patient is able to use them but also puts stress on the hands, wrists, forearms, neck and back, which can lead to upper back ailments and other physical disorders, such as rotator cuff tears.

Second, because they so poorly conform to the body's natural physiology, they're awkward to maneuver and thus inherently unstable. This especially applies to children where the majority of hospitals prescribe walkers instead of crutches to kids under age eleven because of this instability. Adolescents, the elderly, the overweight, the out-of-shape and/or those who have been prescribed painkillers or other medications are also affected—which covers just about all of us. The result is often a loss of balance and an awkward, nasty fall that can reinjure the patient or cause new trauma to the head, wrists, ankles and other areas of the body.

These devices have for years been associated with discomfort and instability. What hasn't been addressed up to now is their basic inflexible, “static” nature. That is, they've been designed to accommodate a patient at his/her initial (and therefore worst) point of pain and discomfort; they aren't designed to “adjust” as the user heals and desires greater mobility. This disadvantage actually retards the recovery of the user who's capable of moving more freely than the device will accommodate.

A user walking with crutches will take a minimum of 2,400 steps, with children taking closer to 3,000. The jarring staccato of each of these steps reverberating wave after wave of pain through though the crutches, further causes discomfort to the entire body however specifically irritates the hands, wrists, elbows, shoulder joints and upper back. These inadequacies no nothing to enhance healing and lead to accelerated fatigue.

Not to be overlooked, these stark, Spartan-like devices, which put users in slumped over, clumsy-looking positions, almost seem purposely designed to make the user feel self-conscious and even stigmatized. Nothing about how they look—nor how they make the tottering user look when trying to stay upright—lends dignity to the patient.

Over recent years, however, medical professionals have learned that the key to rapid recovery from surgery, injury or any incident impacting mobility is to get patients up and walking as naturally as their pain will allow, as quickly as possible. Put it all together and medical professionals who must prescribe the use of these particular mobility aids actually find themselves unintentionally violating their sacred oath to “do no harm.”

In view of the foregoing, there is a need for an improved mobility aid device that addresses various design flaws found in conventional mobility aids.

### SUMMARY OF THE INVENTION

Embodiments of the present invention provide mobility aids, namely, improved cuff crutches, as discussed in greater detail below.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a side view of a cuff crutch in a cuff cane configuration;

FIG. 2 illustrates a side view of a cuff crutch in a cuff crutch configuration;

FIG. 3 illustrates a side view of a cuff crutch in a walking stick configuration;

FIG. 4 illustrates a top perspective view of a cuff of the cuff crutch of FIGS. 1 through 3;

FIG. 5 illustrates a bottom perspective view of the cuff of FIG. 4;

FIG. 6 illustrates a top perspective view of a grip of the cuff crutch of FIGS. 1 through 3;

FIG. 7 illustrates a bottom perspective view of the grip of FIG. 6;

FIG. 8 illustrates a top view of the grip of FIG. 6;

FIG. 9 illustrates a side view of the grip of FIG. 6;

FIG. 10 illustrates a bottom view of the grip of FIG. 6;

FIG. 11 illustrates a top perspective view of an assembled grip of the cuff crutch of FIGS. 1 through 3;

FIG. 12 illustrates a bottom perspective view of the assembled grip of FIG. 11;

FIG. 13 illustrates a top view of the assembled grip of FIG. 11;

FIG. 14 illustrates a side view of the assembled grip of FIG. 11;

FIG. 15 illustrates a bottom view of the assembled grip of FIG. 11;

FIG. 16 illustrates a top perspective view of a grip clip used with the assembled grip of FIG. 11;

FIG. 17 illustrates a bottom perspective view of the grip clip of FIG. 16;

FIG. 18 illustrates a top perspective view of a grip overmold used with the assembled grip of FIG. 11;

FIG. 19 illustrates another top perspective view of the grip overmold of FIG. 18;

FIG. 20 illustrates removal of a cuff portion of the cuff crutch of FIGS. 1 through 3 to convert the device to a cane;

FIG. 21 illustrates a top perspective view of a foot used with the cuff crutch of FIGS. 1 through 3;

FIG. 22 illustrates another top perspective view of the foot of FIG. 21;

FIG. 23 illustrates a perspective view of a foot swivel cover used on the foot of FIG. 21;

FIG. 24 illustrates another perspective view of the foot swivel cover of FIG. 23;

FIG. 25 illustrates another perspective view of the foot swivel cover of FIG. 23;

FIG. 26 illustrates another perspective view of the foot swivel cover of FIG. 23;

FIG. 27 illustrates a top perspective view of an alternative embodiment of a foot usable on a crutch;

FIG. 28 illustrates a bottom perspective view of the foot of FIG. 27;

FIG. 29 illustrates the cuff with a strap attached;

FIG. 30 illustrates a view of a cuff crutch with certain features called out;

FIG. 31 illustrates a cane version with certain features called out; and

FIGS. 32 through 34 illustrate a cane/crutch foot design according to an exemplary embodiment of the present invention.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any apparatus, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a mobility aid in the form of a cuff crutch that can be used in various configurations. The cuff crutch includes an arm cuff positioned at a distal end of a tube that is adjustably positioned into a main tube of the crutch. The main tube may be bent at an angle in a position below a mid-point thereof, that is, the bend is closer to the foot end of the main tube as opposed to the cuff end thereof. A foot tube may be adjustably positioned into the foot end of the main tube and a foot may be disposed on a distal end of the foot tube. By providing the various adjustments, the cuff crutch may be used as a cuff cane, a cuff crutch or a walking stick, as discussed below. The cuff, grip, and foot may include designs that offer various improvements over conventional mobility aids.

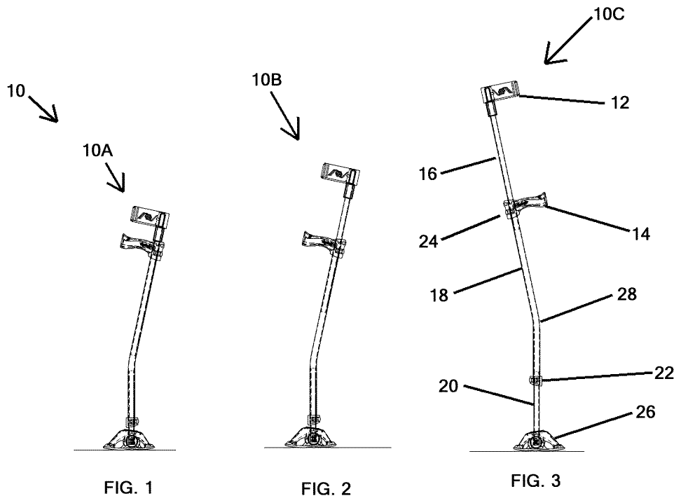

Referring now to FIGS. 1 through 3 there is shown a cuff crutch 10 that is usable, via adjustments as discussed below, in at least three different forms. In the shortest form, the cuff crutch may be used as a cuff cane 10A. In its medium setting, the cuff crutch may be used similar to a conventional cuff crutch 10B. In an elongated setting, the cuff crutch may be used as a walking stick 10C.

The cuff crutch 10 can include a cuff 12 and a grip 14, as described in greater detail below. Further, the cuff crutch 10 can include a main tube 18 having a bend 28 therein. The bend 28 may be located at or below (that is, toward the foot end of the cuff crutch 10) a mid-point along the length thereof. A cuff tube 16 may attach to the cuff 12 at a first end thereof. The cuff tube 16 may, at the opposite end, be slidably engaged with the main tube 18. A connector 24 may provide for a telescoping engagement between the main tube 18 and the cuff tube 16. The connector 24 may be similar to those known in the art that provide a telescoping engagement between two tubular members. Similarly, a foot tube 20 may telescopingly engage with the main tube 18 via a connector 22. A foot 26, as discussed below, may be disposed on a distal end of the foot tube 20.

In some embodiments, the tubes 20, 18, 16 may be formed in a round shape. In other embodiments, the shape of the tubes 20, 18, 16 may be formed as a non-round shape. In this embodiment, rotation of the tube about connectors 22, 24 may be prevented, thus keeping the cuff, grip and foot aligned. In some embodiments, this non-round shape may be a rounded square shape.

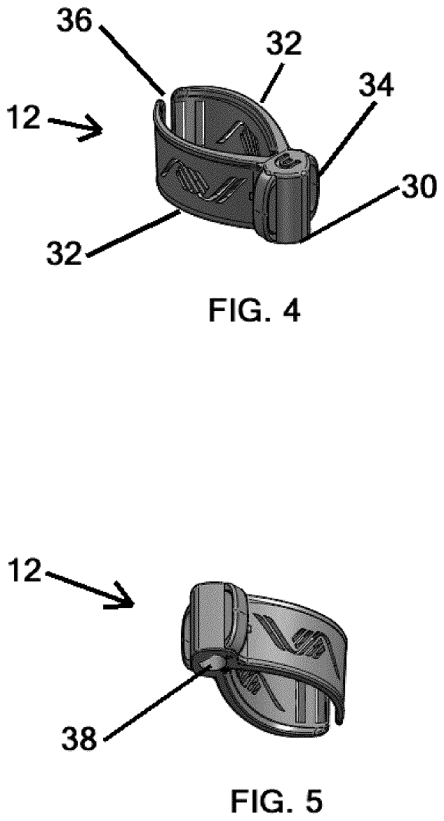

Referring to FIGS. 4 and 5, the cuff 12 can include a tube attachment side 30 with cuff arms 32 extending therefrom, typically in a rounded V-shape as shown. The tube attachment side 30 can include an opening 38 for receiving the cuff tube 16 therein. The cuff arms 32 can curve back toward each other at a distal end, relative to the tube attachment side 30, thereof, with a space 36 formed between the ends of the cuff arms 32. In some embodiments, the cuff 12 can be made from a relatively flexible and soft material, such as a thermoplastic rubber material having a 70 durometer.

In some embodiments, slots may be formed near distal ends of the cuff arms 32. These slots may be helpful for closing the space 36 formed between the ends of the cuff arms 32 or at least to keep the space 36 from further opening during use thereof.

Slots 34 may be formed on one or both sides of the tube attachment side 30. Typically, the slots 34 are formed on each side of the tube attachment side 30. A link (not shown) may be extending between slots 34 in a pair of the cuff crutches 10. The link can be an adjustable tether that joins the two cuff crutches 10 via a band across the waist of the user, thereby addressing an important problem in ambulation for physicians—gait control of patient ambulation.

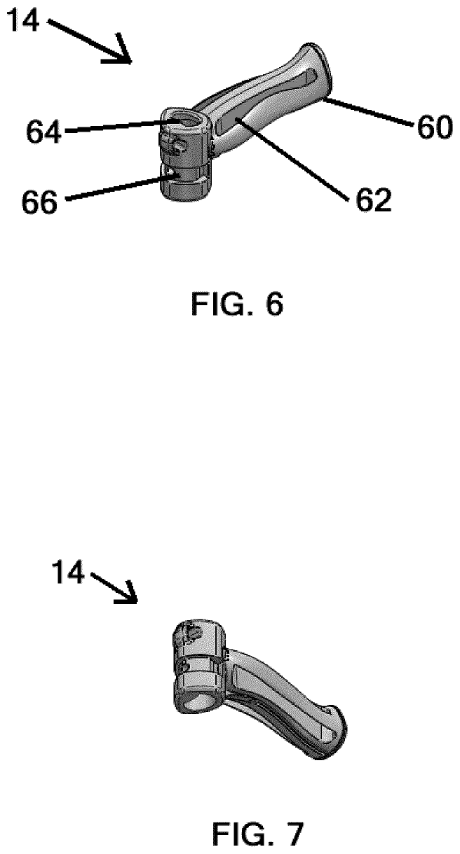

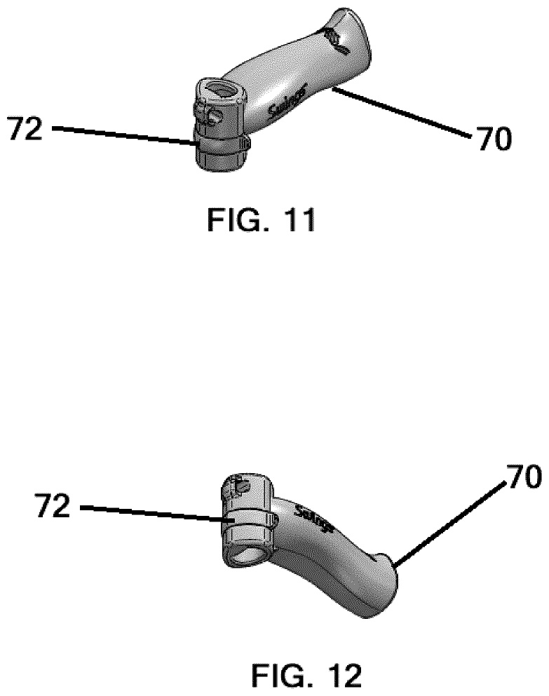

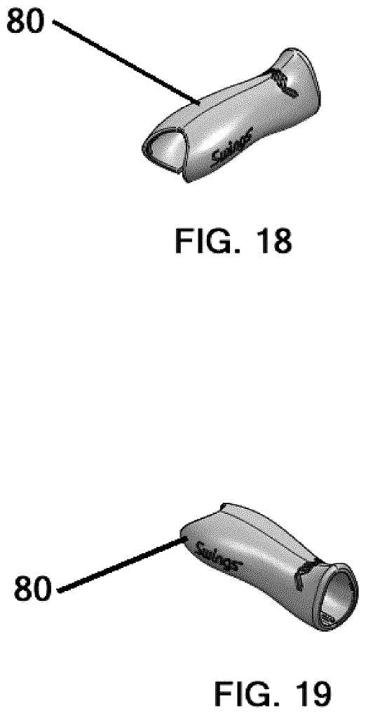

Referring now to FIGS. 6 through 19, a grip 14 is described. The grip 14 can be formed from a grip base 60 (see FIGS. 6 and 7) and an overmold cover 80 (see FIGS. 18 and 19). The grip base 60 can include a plurality of slots 62 cut along a length thereof. The slots 62 provide resilient flexibility in the grip base 60, where a user's grip or pressure placed on the grip 14 may cause some flexure in the grip base 60, enhancing user comfort.

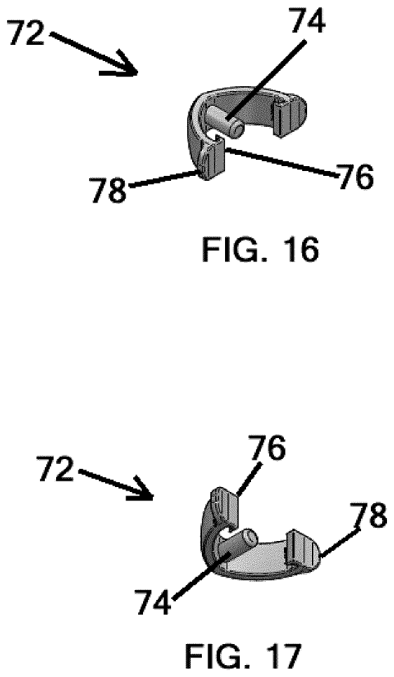

The grip 14 can include a tube attachment end having an opening 64 for receiving the main tube 18 therewithin. A clip 72 (see FIGS. 16 and 17) may fit into a clip receiver 66 formed in the grip 14. The clip 72 may be formed in a C-shape with ends having an inward extending portion 76 and outward extending portions 78 at each end of the C-shape. A center pin 74 may extend along an interior of the C-shape. The center pin 74 may engage the main tube 18 to help maintain the position of the grip 14 on the main tube 18. In some embodiments, the main tube 18 may have a plurality of holes disposed therealong to permit adjustability of the grip 14 along the main tube 18. A user can simply remove the clip 72, slide the grip 14 to the desired location, and replace the clip 72 into the appropriate hole along the main tube 18.

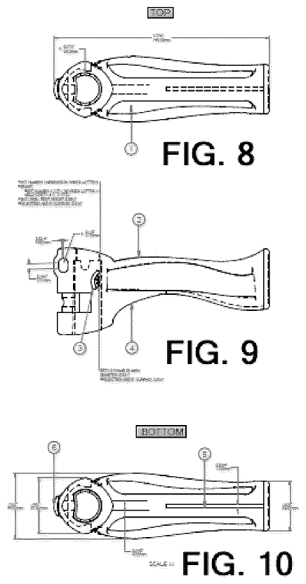

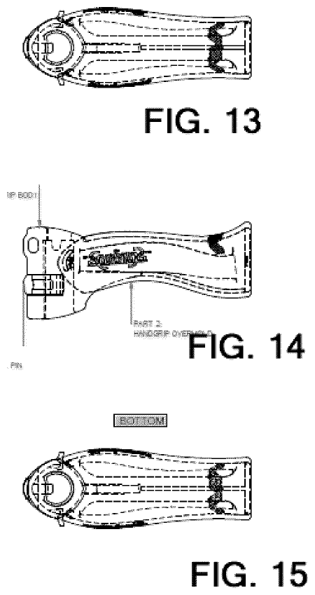

The grip base 60 may have an ergonomic shape, as shown in FIGS. 8 through 10, where the grip 14 with overmold cover 80 may continue that ergonomic shape, as shown in FIGS. 13 through 15. Positioning members may be formed inside the overmold cover 80 that prevent rotation of the overmold cover 80 relative to the grip base 60. The grip 14 may be designed to be symmetrical so that a user may use the cuff crutch 10 on either their right hand side of their left hand side.

Various accessories may be incorporated into the grip 14 or may be disposed at a forward facing end thereof. Such accessories may include a light, GPS unit, safety strobe, or the like.

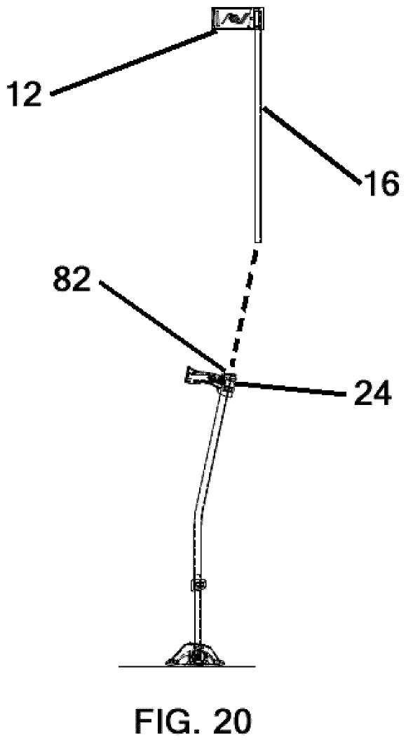

In some embodiments, the cuff tube 16 can be removed from the main tube 18 as shown in the dashed line of FIG. 20. A cap 82 may be placed on the end of the main tube 18 to form a cane like structure. Therefore, the cuff crutch 10 may be usable not only in the manners shown in FIGS. 1 through 3, but also as a cane-type mobility aid, as shown in FIG. 20.

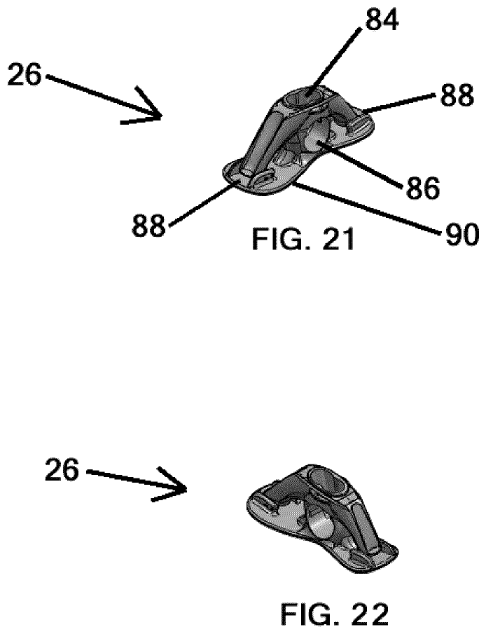

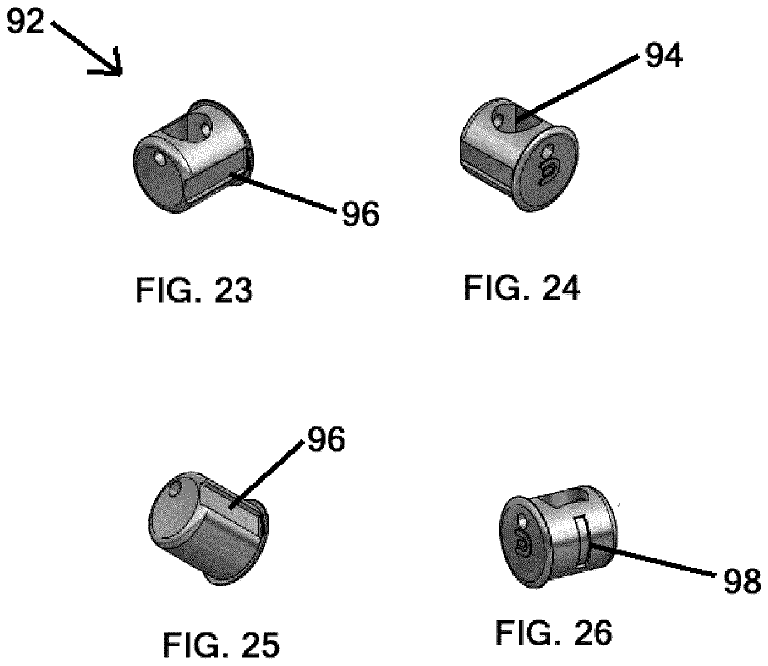

Referring now to FIGS. 21 through 26, the foot 26 may be formed as an articulating foot that permits a pivoting movement of the foot tube 20 (and, therefore, the rest of the cuff crutch attached thereto) relative to the foot 26. The foot 26 can include an opening 84 for receiving the foot tube 20 therein. In some embodiments, the opening 84 may be shaped as a FIG. 8, with a slightly narrowed central side portions. Such a design may be useful in providing a two-stage pivot system.

A side opening 86 may be formed on each side of the foot 26 for receiving a foot swivel cover 92 therein. The foot swivel cover 92 can include an opening 94 for receiving the foot tube 20 therein. Track slots 96, 98 may be formed in the foot swivel cover 92 to align with protrusions formed in the side opening 86 of the foot 26.

The base 90 of the foot 26 may flexibly attach to members that extend forward and back from the opening 84. Various attachment mechanism may be used to secure the toe end and heel end of the foot 26 so that the base 90 may flex during use thereof. The foot 26 can maximize the amount of time the foot stays flat on a given surface to increase the amount of friction throughout the entire movement and gait of the patient.

It should be understood that, while the cuff crutch 10 may be illustrated with a specific cuff 12, grip 14 and foot 26, the cuff crutch 10 may be used with any one or more of these features, or none of these specific design features, where novelty may be found in the overall shaped of the cuff crutch, for example. Of course, the cuff crutch 10 may include only the cuff 12, as herein shown and described, with a conventional grip and foot, or may include only the grip 14, as herein shown and described, with a conventional cuff and foot, or may include only the foot 26, as herein shown and described, with a convention cuff and grip, or may include two of the unique cuff 12, grip 14 or foot 26, with the third of these components being a conventional design.

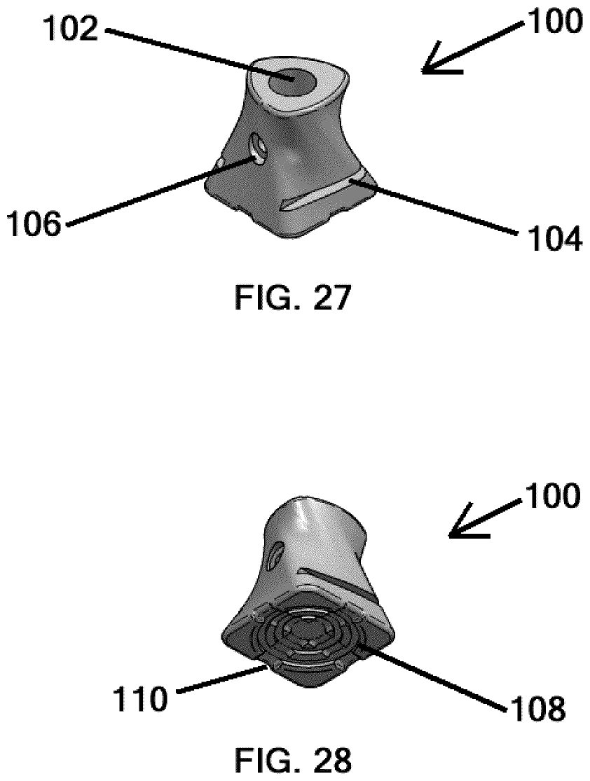

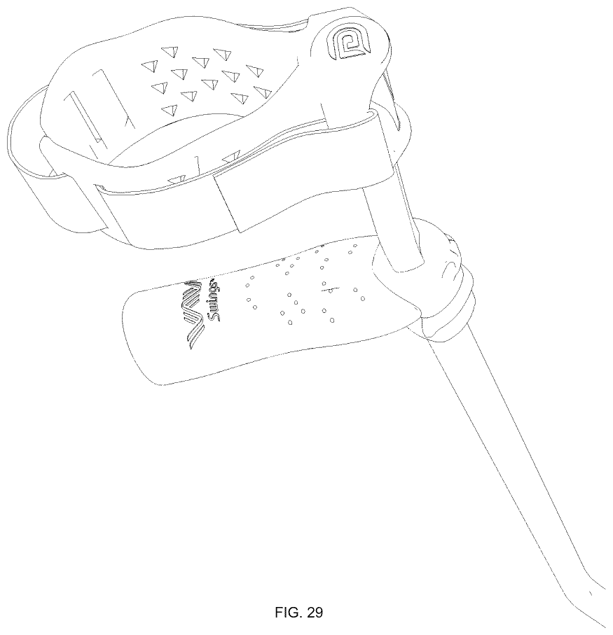

Along these lines and referring now to FIGS. 27 and 28, it should be understood that other options for the foot may be used, such as foot 100. This foot 100 may include an opening 102 for receiving the foot tube 20 therein. An opening 106 may be formed in the foot 100 for placing a connector (not shown) for attaching the foot 100 to the foot tube 20. The foot 100 can include a slot 104 cut into a forward side and a rearward side thereof. During use, the foot 100 may flex as the crutch is moved forward and rearward, while maintaining maximum contact between the base 108 of the foot 100 with the surface. The base 108 may include slots cut therein to permit water to drain away during use. Of course, other foot designs may be useable with the cuff crutch 10 of the present invention.

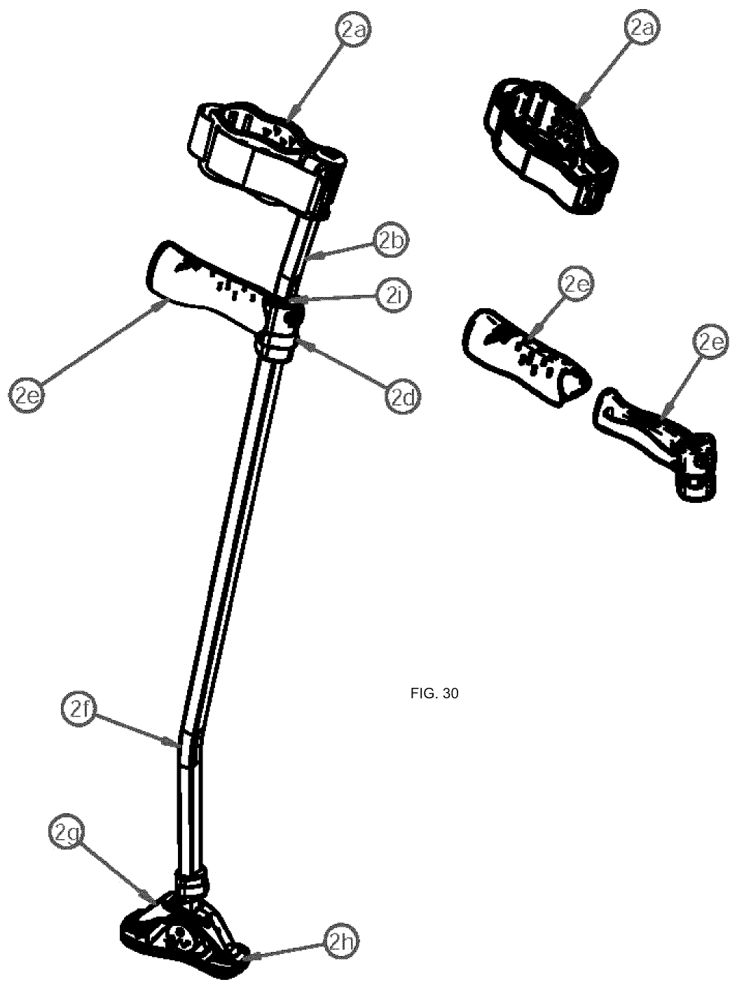

Referring to FIG. 30, aspects of the present invention can provide the following features:
2a. Flexible “V” shaped Cuff with elastic Cuff Retaining Band,
2b. Adjustable Cuff position—wrist to elbow,
2c. Adult & Youth sizes available,
2d. Adjustable Hand Grip position,
2e. Springy Hand Grip Body with replaceable pad,
2f. Lower bend in Main Base tube to assure full/flat tread contact with ground,
2g. New 2-Piece oriented Articulating Foot with Hub Options—Body shared with ProSwings/Versa,
2h. Molded-in pads in Rocker Sockets, and
2i. Convertible to Versa Cane

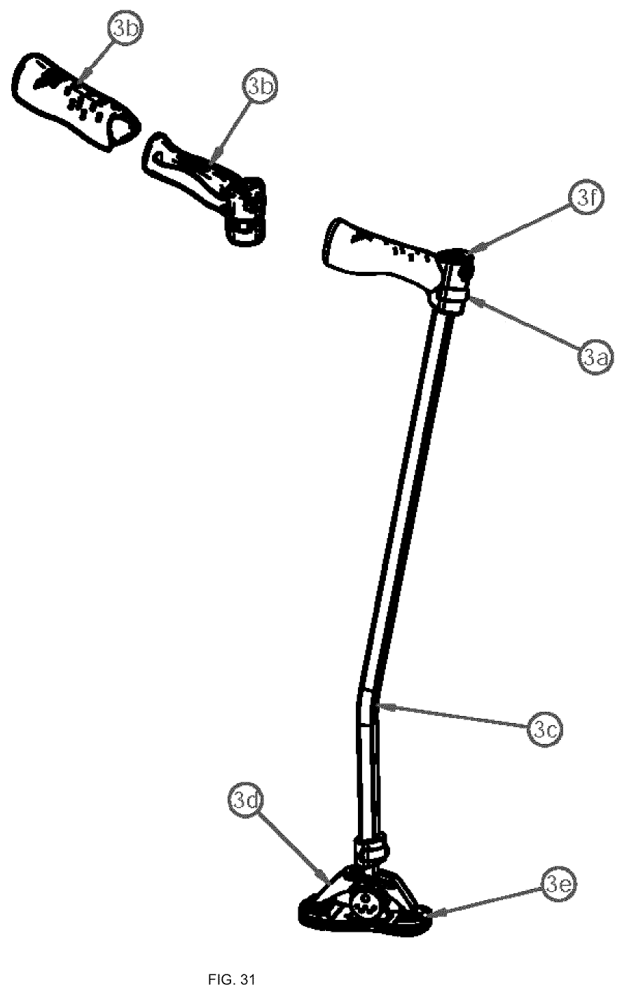

Referring to FIG. 31, aspects of the present invention, converted into a cane (or formed initially as a cane), can provide the following features:
3a. Adjustable Hand Grip position,
3b. Springy Hand Grip Body with replaceable pad,
3c. Lower bend in Main Base tube to assure full/flat tread contact with ground,
3d. New 2-Piece oriented Articulating Foot with Hub Options—Body shared with ProSwings/Versa,
3e. Molded-in pads in Rocker Sockets, and
3f. Convertible to ProVersa Cuff Crutch

In both embodiments, the body of the cane or crutch, from the grip to the foot, includes a bend below a midpoint of the body, with a linear portion between the bend and the foot. If this linear portion is continued upward toward the grip, such an imaginary linear line would intersect the grip. Typically, this intersection would be at a middle section along a length of the grip, even more typically, at the midpoint of the length of the grip.

While the above discusses the embodiment of FIG. 31 being designed from converting the cuff crutch, in some embodiments, the cane version may be made as is, without the ability to convert into a cuff crutch.

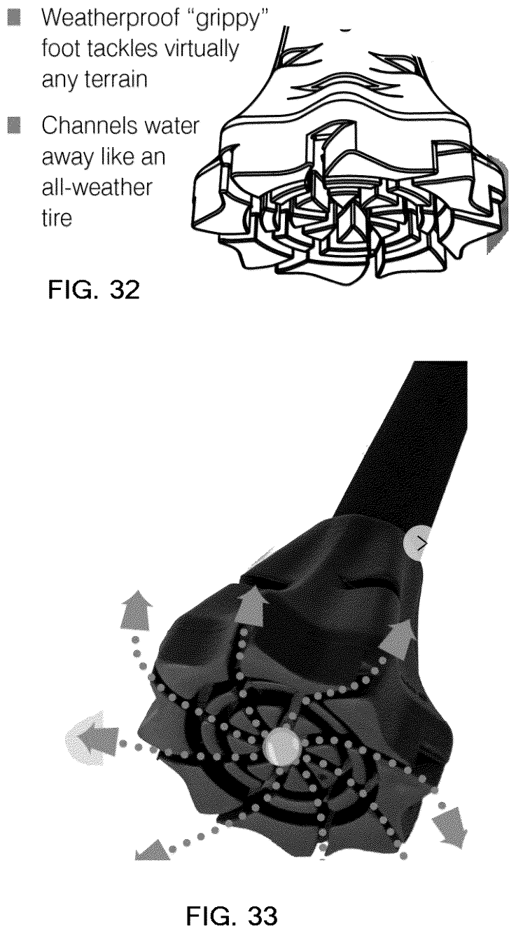

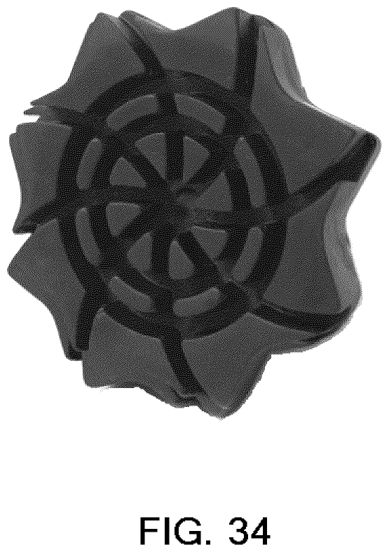

Referring to FIGS. 32 through 34, a foot design is shown, where a central through hole communicates with a plurality of channels to an outer, bottom periphery of the foot. Such a design can tread water and provide a grip in wet conditions. Further, like the foot describes above, slits formed in the body of the foot can permit the foot to flex, allowing more of the base of the foot to contact a surface as the cane is tilted.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A mobility aid as herein shown and described.
